(19) United States
(12) Patent Application Publication
(10) Pub. No.: US 2017/0358015 A1
(43) Pub. Date: Dec. 14, 2017

(54) User Location History Implies Diminished Review

(71) Applicant: Google Inc., Mountain View, CA (US)

(72) Inventors: Daniel Victor Klein, Pittsburgh, PA (US); Dean Kenneth Jackson, Pittsburgh, PA (US)

(73) Assignee: Google Inc., Mountain View, CA (US)

(21) Appl. No.: 14/246,265

(22) Filed: Apr. 7, 2014

(51) Int. Cl. G06Q 30/02

(52) U.S. Cl. CPC G06Q 30/0282; G06Q 30/0201

(57) ABSTRACT

Systems and methods for providing reviews are provided. One example system includes one or more computing devices. The system includes one or more non-transitory computer-readable media storing instructions that, when executed by the one or more computing devices, cause the one or more computing devices to perform operations. The operations include identifying, based on a location history associated with a user, a first signal. The first signal comprises a frequency of visits by the user to a first point of interest over a first time period. The operations include identifying, based on the location history associated with the user, a change in the first signal after the first time period. The operations include providing a diminished review for the user with respect to the first point of interest when the identified change comprises a decrease in the frequency of visits by the user to the first point of interest.

### FIELD

The present disclosure relates generally to systems and methods for providing reviews. In particular, the present disclosure relates to systems and methods for providing a diminished review for a point of interest when a frequency of visits by one or more users to the point of interest decreases.

### BACKGROUND

Review platforms can provide an opportunity for users to contribute or browse reviews of points of interest. For example, after eating at a particular restaurant, a user can visit a webpage in the review platform that corresponds to the particular restaurant and can contribute a review. The review can be numeric (e.g. 6/10 or 3 stars out of 5), textual (e.g. “great wine selection, but poor service”), or other formats.

Some review platforms can also offer functionality for a user to upload photos, tag friends, or other interactive features. Thus, review platforms can be embedded within or an extension or feature of social media platforms, mapping applications, or some combination of mapping, social, and review services.

Furthermore, once a review platform has accumulated a significant number of reviews it can be a useful resource for users to identify new entities or locales to visit or experience. For example, a user can visit the review platform to search for a restaurant at which to eat, a store at which to shop, or a place to have drinks with friends. The review platform can provide search results based on location, quality according to the reviews, pricing, and/or keywords included in textual reviews.

However, one problem associated with review platforms is collecting a significant number of reviews. For example, a large majority of people do not take the time to visit the review platform and contribute a review for each point of interest they visit throughout a day.

Furthermore, even after a review is contributed by a user, the user's opinion of the point of interest may change, rendering the contributed review outdated and inaccurate. For example, a restaurant for which the user previously provided a positive review may come under new ownership or experience a change in kitchen staff that causes the quality of the restaurant to decrease. As such, the user may cease visiting the restaurant or otherwise decrease a frequency of visits. However, the user may not take the time to return to the review platform and update their review.

Thus, a location history associated with a user can provide one or more signals that indicate an implied review of points of interest. Therefore, systems and methods for using user location information to provide reviews are needed. In particular, systems and methods for providing a diminished review for a point of interest when a frequency of visits by one or more users to the point of interest decreases are desirable.

### SUMMARY

Aspects and advantages of the present disclosure will be set forth in part in the following description, or may be obvious from the description, or may be learned through practice of embodiments of the present disclosure.

One example aspect of the present disclosure is directed to a system for providing reviews. The system includes one or more computing devices. The system includes one or more non-transitory computer-readable media storing instructions that, when executed by the one or more computing devices, cause the one or more computing devices to perform operations. The operations include identifying, based on a location history associated with a user, a first signal. The first signal describes a frequency of visits by the user to a first point of interest over a first time period. The operations include identifying, based on the location history associated with the user, a change in the first signal after the first time period. The operations include providing a diminished review for the user with respect to the first point of interest when the identified change includes a decrease in the frequency of visits by the user to the first point of interest.

These and other features, aspects, and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling description of the present disclosure, directed to one of ordinary skill in the art, is set forth in the specification, which makes reference to the appended figures, in which:

FIG. 1 depicts an example system for providing reviews according to an example embodiment of the present disclosure;

FIG. 2 depicts a flow chart of an example method for providing reviews according to an example embodiment of the present disclosure;

FIG. 3 depicts a flow chart of an example method for providing reviews according to an example embodiment of the present disclosure;

FIG. 4 depicts a flow chart of an example method for providing reviews according to an example embodiment of the present disclosure;

FIG. 5 depicts a flow chart of an example method for providing reviews according to an example embodiment of the present disclosure; and

FIG. 6 depicts a flow chart of an example method for providing reviews according to an example embodiment of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed to systems and methods for providing a diminished review for a point of interest when a frequency of visits by one or more users to the point of interest decreases. In particular, a location history for a user can provide a history of visits by the user to points of interest over time. A system implementing the present disclosure can identify a first signal exhibited by the location history. The first signal can describe a frequency of visits by the user to a first point of interest over a first time period. A change in the first signal after the first time period can be identified. If the identified change includes a decrease in the frequency of visits by the user to the first point of interest, then it can be assumed that the first point of interest has become less favorable in the user's opinion. As a result, a diminished review can be provided for the user with respect to the first point of interest. As an example, providing a diminished review can include degrading or otherwise reducing the impact of a previous review contributed by the user with respect to the first point of interest. In such fashion, a location history associated with a user be analyzed to identify implied reviews of points of interest, as reflected by the frequency at which the user respectively visits the points of interest.

More particularly, in some embodiments of the present disclosure, a plurality of location updates can be received from one or more mobile devices (e.g. a smartphone) associated with each of a plurality of users. The plurality of location updates can be used to build a location history for each of the users. The location history of each user can provide a history of visits by such user to points of interest over time.

Points of interest can include various locations and/or entities such as particular food establishments (e.g. traditional restaurants or food trucks or other non-traditional food vendors), venues, parks, stores, landmarks, car washes, auto service centers, oil change services, coffee shops, professional services (e.g. doctors or lawyers) hair salons, amusement parks, individual transit stops, or other points of interest. Furthermore, in some embodiments a plurality of points of interest can be treated aggregately as a single point of interest. For example, a shopping mall containing a plurality of retail stores can be treated as a single point of interest.

Thus, in some embodiments, in order to obtain the benefits of the techniques described herein, the user may be required to allow the collection and analysis of location information associated with the user or her device. For example, in some embodiments, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed.

According to an aspect of the present disclosure, the location history for a user can be analyzed to identify a first signal. For example, in some embodiments, the first signal is identified when it exceeds a threshold value.

The first signal can describe a frequency of visits by the user to a particular point of interest over a first time period. For example, the frequency can equal a number of visits per a standard increment of time (e.g. once per month for the last six months).

As another example, the frequency can equal a number of visits by the user to the particular point of interest per a number of instances in which the user was located in a region in which the particular point of interest is located. For example, the region can be a neighborhood or city. Thus, if the particular point of interest is located in Chicago and the user has visited the particular point of interest each of three times the user has been located in Chicago, then the above-noted formulation of frequency will reflect the user's positive opinion of the particular point of interest with greater accuracy than a frequency based on units of time regardless of user location.

As yet another example, the frequency can equal a number of visits by the user to the particular point of interest per an amount of time for which the user was located in the region in which the particular point of interest is located. Thus, for example, the frequency can reflect the number of times the user visited the point of interest per a total amount of time the user was located in Chicago.

According to another aspect of the present disclosure, a change can be identified in the first signal after the first time period. For example, the change can be a decrease in the frequency of visits by the user to the particular point of interest.

As an example, identifying the change in the first signal after the first time period can include identifying when the first signal decreases to below the threshold value. As another example, identifying the change in the first signal after the first time period can include identifying when the first signal decreases by greater than a threshold amount or by greater than a threshold percentage.

Thus, if the user's location history exhibits a change in frequency of visits from a first time period to a second time period, it can be assumed that the user's opinion of the point of interest has diminished or otherwise changed.

As such, when the identified change in the first signal is a decrease in the frequency of visits by the user to the particular point of interest, a diminished review can be provided for the user with respect to the first point of interest. For example, providing a diminished review can include providing a negative review for the user with respect to the point of interest.

As another example, providing the diminished review can include reducing a review score previously provided by the user for the point of interest. For example, if the user previously provided a review score of 4/5 stars, then providing the diminished review can include reducing the review score to 3/5 stars.

Alternatively or additionally, providing the diminished review can include prompting the user to confirm or edit/elaborate on the previously contributed review. For example, the user can be prompted to confirm a reduction in the user's previous review.

As yet another example, providing the diminished review can include accelerating a decay associated with a review of the particular point of interest that was previously contributed by the user during the first time period. For example, in certain systems, user-contributed reviews may have a certain decay period in which their influence on search or rating systems wanes. Thus, providing the diminished review can include accelerating this decay period for the review previously contributed by the user.

As another example, providing the diminished review can include decreasing a probability that the point of interest is recommended as a search result. For example, in certain systems, the reviews for a particular point of interest can impact the probability that such particular point of interest is deemed a relevant and appropriate search result (e.g. higher rated points of interest are provided more often than lower rated points of interest). Thus, providing the diminished review can include reducing the probability that the point of interest is provided as a search result. For example, the impact of one or more reviews (e.g. the review previously contributed by the user) on search results can be eliminated or decreased.

In further embodiments of the present disclosure, additional signals are considered to ensure that the change in the frequency of visits by the user is actually due to a change in the user's opinion regarding the point of interest, rather than other factors such as, for example, the user changing her residence or workplace to a new location or the user changing her visitation patterns for all points of interest, rather than the particular point of interest being considered.

As an example, in some embodiments, a second signal can be identified that describes an aggregate frequency of visits by the user to one or more other points of interest. The other points of interest can be points of interest that are located in the same region (e.g. neighborhood) as the first point of interest. If the aggregate frequency of visits to the one or more other points of interest in the same region shows a decrease that corresponds with the decrease in frequency of visits to the first point of interest, then perhaps the user has moved away or has found a different region which she prefers to visit. In such scenario, the user's opinion of the first point of interest has not necessarily diminished and, therefore, a diminished review may not be appropriate.

However, if the aggregate frequency of visits to the one or more other points of interest in the same region does not show a corresponding decrease, then the user is visiting points of interest in the region with the same frequency except for the first point of interest. In such situation, it can be assumed that the user's opinion of the first point of interest has diminished and, therefore, a diminished review can be provided.

As another example, in some embodiments, a second signal can be identified that describes an aggregate frequency of visits by the user to one or more other points of interest. The other points of interest can be points of interest that share a categorization with the first point of interest (e.g. a style of restaurant such as “Italian Restaurants”). If the aggregate frequency of visits to the one or more other points of interest with the same categorization shows a decrease that corresponds with the decrease in frequency of visits to the first point of interest, then perhaps the user has grown tired of Italian restaurants or is exploring additional flavors/categories. In such scenario, the user's opinion of the first point of interest has not necessarily diminished and, therefore, a diminished review may not be appropriate.

However, if the aggregate frequency of visits to the one or more other points of interest with the same categorization does not show a corresponding decrease, then the user is visiting points of interest of the same categorization with the same frequency except for the first point of interest. In such situation, it can be assumed that the user's opinion of the first point of interest has diminished and, therefore, a diminished review can be provided.

Alternatively, in some embodiments, the diminished review can be provided only when the aggregate frequency of visits by the user to the one or more other points of interest with the same categorization shows a corresponding increase. Thus, if the user has increased the frequency at which she visits one or more alternative Italian restaurants, then it can be assumed that the alternative restaurants have replaced the first point of interest as the user's preferred selection. Therefore, a diminished review may be appropriate.

As yet another example, in some embodiments, a second signal can be identified that describes an aggregate frequency of visits by one or more other users to the first point of interest. If the aggregate frequency of visits by the one or more other users to the first point of interest does not show a decrease that corresponds with the decrease in frequency of visits by the first user to the first point of interest, then it appears that only the first user's opinion of the point of interest has diminished and, therefore, the diminished review can be provided for the first user but not affect the overall score of the point of interest.

However, if the aggregate frequency of visits by the one or more other users to the first point of interest does show a decrease that corresponds with the decrease in frequency of visits by the first user to the first point of interest, then it can be assumed that something has changed at the point of interest which has caused all of the users to decrease their aggregate frequency of visits. In such situation, the diminished review can be provided for the first user and also can affect the overall score or reputation of the point of interest. For example, the probability that the point of interest is provided as a search result can be decreased. Further, in some implementations, the one or more other users used to define the second signal can be limited to users that share a region, share preferences, or have other corresponding features with respect to the first user.

In yet further embodiments of the present disclosure, the methods of the present disclosure discussed above can be applied to a plurality location histories associated with a plurality of users. In particular, a first signal can be identified that describes an aggregate frequency of visits by the plurality of users to a points of interest over a first time period. A change in the first signal can be identified after the first time period. When the identified change is a decrease in the aggregate frequency of the plurality of users to the first point of interest, a diminished review can be provided for the first point of interest. In such fashion, when a plurality of users decrease the aggregate frequency at which they visit a point of interest, it can be assumed that something has changed at the point of interest which has diminished its desirability. Therefore, a diminished review may be appropriate.

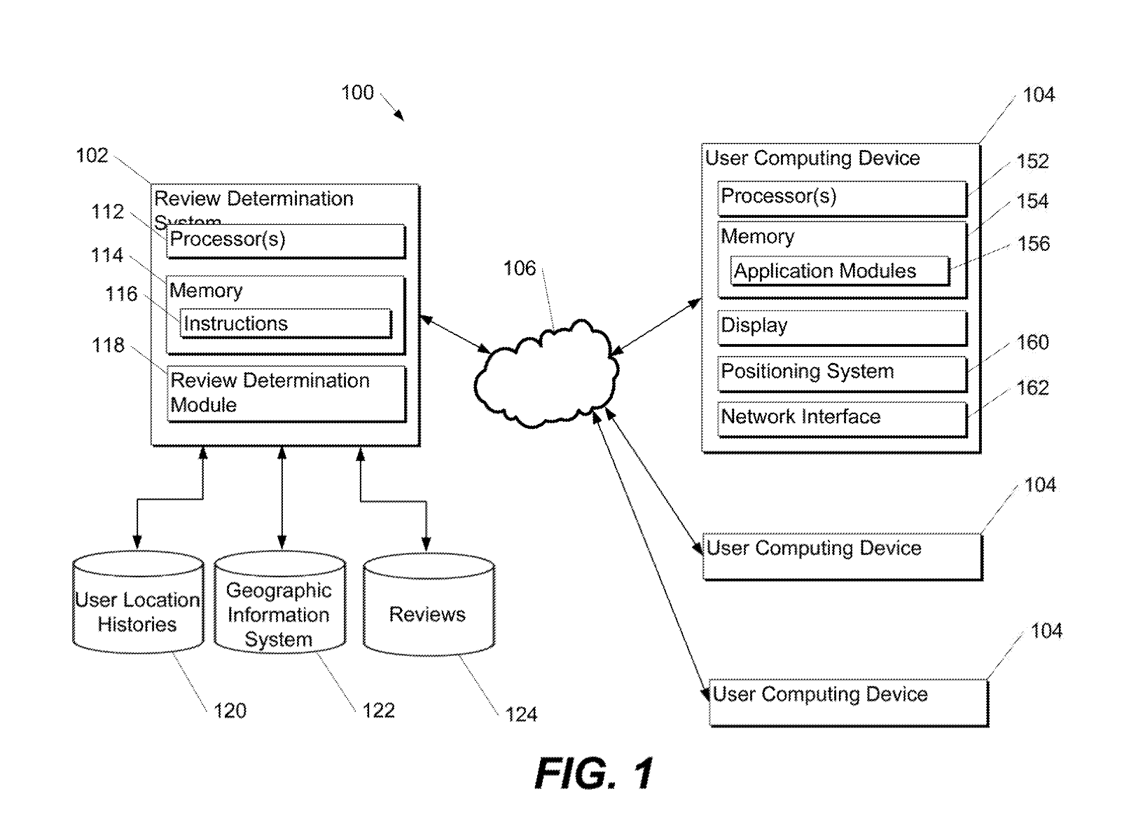

With reference now to the FIGS., example embodiments of the present disclosure will be discussed in further detail. FIG. 1 depicts an exemplary system 100 according to an exemplary embodiment of the present disclosure.

System 100 can include a client-server architecture, where a review determination system 102 communicates with one or more user computing devices 104, 106, and 108 over a network 106. Although three user computing devices 104, 106, and 108 are illustrated in FIG. 1, any number of user computing devices can be connected to review determination system 102 over network 106.

User computing devices 104, 106, and 108 can be, for example, a computing device having a processor 152 and a memory 154, such as a wireless mobile device, a personal digital assistant (PDA), smartphone, tablet, navigation system located in a vehicle, handheld GPS system, laptop computer, computing-enabled watch, computing-enabled eyeglasses, embedded computing system, or other such devices/systems. In short, user computing device 104 can be any computer, device, or system that can interact with the review determination system 102 (e.g. by sending and receiving data).

Processor 152 of user computing device 104 can be any suitable processing device (e.g. microprocessor or microcontroller) and can be one processor or a plurality of processors that are operably connected. The memory 154 can include any suitable computing system or media, including, but not limited to, non-transitory computer-readable media, RAM, ROM, hard drives, flash drives, or other memory devices.

Memory 154 can include any number of computer-readable instructions or other stored data. In particular, memory 154 can include, store, or provide one or more application modules 156. When implemented by processor 152, application modules 156 can respectively cause or instruct processor 152 to perform operations consistent with the present disclosure, such as, for example, running an application that transmits location data to review determination system 102 in addition to performing any number of arbitrary operations. Application modules 156 can include, for example, a mapping application or a browser application.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example, computer executable instructions that are stored in a tangible computer-readable storage medium such as RAM hard disk or optical or magnetic media.

User computing device 104 can further include a positioning system 160. Positioning system 160 can determine a current geographic location of user computing device 104 and communicate such geographic location to review determination system 102 over network 106. The positioning system 160 can be any device or circuitry for analyzing the position of the user computing device 104. For example, the positioning system 160 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using multilateration and/or proximity to cellular towers or WiFi hotspots, and/or other suitable techniques for determining position.

In the instance in which the user consents to the use of positional or location data, the positioning system 160 can analyze the position of the user computing device 104 as the user moves around in the world and provide the user location information to the review determination system 102 over network 106. As will be discussed further later, each of such location updates can be used to build a user location history for a user associated with user computing device 104.

Thus, in some embodiments, in order to obtain the benefits of the techniques described herein, the user may be required to allow the collection and analysis of location information associated with the user or her device. For example, in some embodiments, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed.

User computing device 104 can further include a network interface 162. Network interface 162 can include any suitable components for interfacing with one more networks, including for example, transmitters, receivers, ports, controllers, antennas, or other suitable components.

Review determination system 102 can be implemented using one or more computing devices (e.g. server computing devices) and can include a processor 112 and a memory 114. In the event that review determination system 102 includes a plurality of computing devices, the plurality of computing devices can perform operations according to any suitable computing architecture, including a parallel computing architecture, a sequential computing architecture, or combinations thereof.

Processor 112 can be any suitable processing device and can be one processor or a plurality of processors which are operably connected. The memory 114 can include any suitable computing system or media, including, but not limited to, non-transitory computer-readable media, RAM, ROM, hard drives, flash drives, or other memory devices.

Memory 114 can store instructions 116 that cause processor 112 to perform operations to implement the present disclosure. Review determination system can communicate with user computing device 104 over network 106 by sending and receiving data.

Network 106 can be any type of communications network, such as a local area network (e.g., intranet), wide area network (e.g., Internet), or some combination thereof and can include any number of wired or wireless links. In general, communication between the review determination system 102 and a user computing device 104 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Preferably, however, user computing device 104 can freely move throughout the world and communicate with review determination system 102 in a wireless fashion.

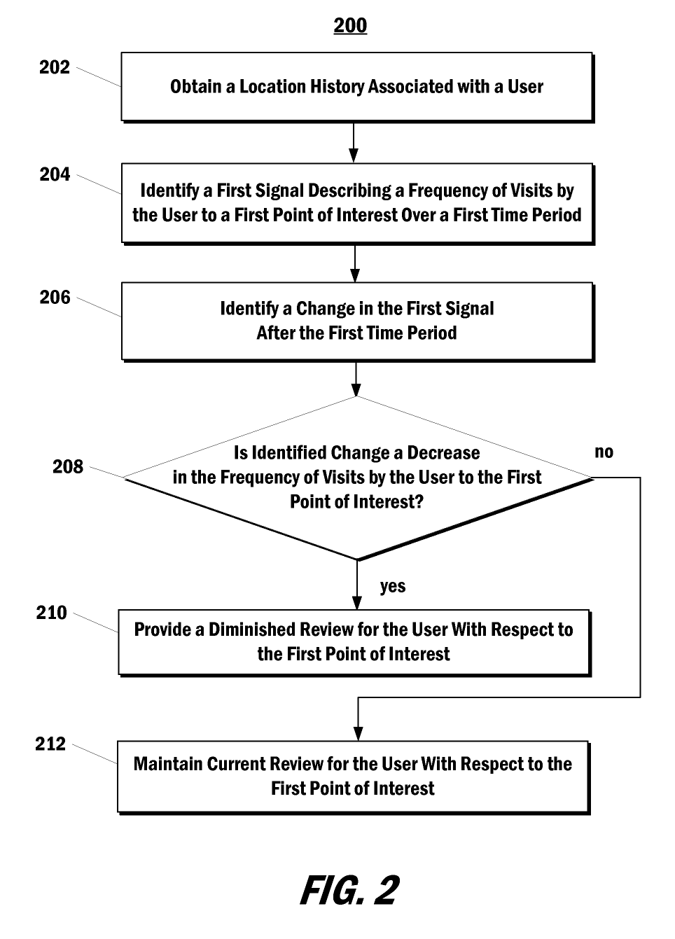

According to an aspect of the present disclosure, review determination system 102 can include a review determination module 118. Review determination module 118 can be implemented to identify one or more signals exhibited by a user location history and provide one or more reviews implied by the one or more signals. In particular, review determination module 118 can be implemented to perform aspects of the methods of FIGS. 2-6.

As an example, review determination module 118 can be implemented to identify, based on a location history associated with a user, a first signal describing a frequency of visits by the user to a first point of interest over a first time period; identify, based on the location history associated with the user, a change in the first signal after the first time period; and provide a diminished review for the user with respect to the first point of interest when the identified change includes a decrease in the frequency of visits by the user to the first point of interest

Review determination system 102 can be coupled to or in communication with one or more databases, including a database providing user location histories 120, a geographic information system 122, and review database 124. Although databases 120, 122, and 124 are depicted in FIG. 1 as external to review determination system 102, one or more of such databases can be included in memory 114 of review determination system 102. Further, databases 120, 122, and 124 can each correspond to a plurality of databases rather than a single data source.

According to another aspect of the present disclosure, user location histories database 120 can store or provide a plurality of location histories respectively associated with a plurality of users. In particular, when a user elects to participate and has signed into her user account with respect to one or more of user computing devices 104, 106, and 108, then such user computing device can periodically send a location update to review determination system 102 over network 106. Alternatively, the user location histories 120 can be built and maintained by a computing system that is separate and unique from review determination system 102 and the user location histories 120 can simply be accessed by review determination system 102.

For example, each location update can identify the presently active user account and a unique device identifier that corresponds to the device providing the update. Each location update can further include a location (e.g. latitude and longitude) and a timestamp identifying the date and time of day. In some implementations, location updates can further include an accuracy indicator and/or other identifying information such as an originating IP address or a WiFi or cell tower identifier.

Additional information can be used to build or supplement a user location history as well. As an example, whenever a user is logged into a user account and performs a web search or uses one or more applications, such as a mapping application, it is possible that such interaction can result in obtaining the user's location. Therefore, an entry can be formed in the associated user location history based on such interaction. As another example, if a user provides consent, transaction data from a digital wallet can be used to identify locations visited by the user.

All received location updates can be stored and associated with a particular user so that a user location history is built over time. Furthermore, in the event that the location reports provided by the user computing device 104 simply provide a geo-location (e.g. a latitude and longitude), one or more algorithms can be applied to such location data to identify a particular point of interest that the user likely visited. Thus, the user location history for each user can provide a history of visits by such user to points of interest over time.

Geographic information system 122 can store or provide geospatial data to be used by review determination system 102. Exemplary geospatial data includes geographic imagery (e.g., digital maps, satellite images, aerial photographs, street-level photographs, synthetic models, etc.), tables, vector data (e.g. vector representations of roads, parcels, buildings, etc.), point of interest data, or other suitable geospatial data.

Review database 124 can store a plurality of reviews respectively associated with a plurality of points of interest. Furthermore, information or statistics concerning the reviews can be included in the review database 124 as well. For example, the user who contributed each review and the date of contribution can be accessible by review determination system 102.

FIG. 2 depicts a flow chart of an example method (200) for providing reviews according to an example embodiment of the present disclosure. Although method (200) will be discussed with reference to system 100 of FIG. 1, method (200) can be performed by any suitable computing system.

In addition, FIG. 2 depicts steps performed in a particular order for purposes of illustration and discussion. Those of ordinary skill in the art, using the disclosures provided herein, will understand that the various steps of method (200) can be omitted, adapted, and/or rearranged in various ways without departing from the scope of the present disclosure.

At (202) a location history associated with a user can be obtained. For example, review determination system 102 can obtain a location history associated with a user from database 120. The obtained location history can describe a history of visits by the user to one or more points of interest.

At (204) a first signal exhibited by the location history obtained at (202) can be identified. In some embodiments, the first signal can be identified at (204) due to the first signal exceeding a threshold value. For example, review determination system 102 can implement review determination module 118 to analyze the obtained location history and identify the first signal.

The first signal can describe a frequency of visits by the user to a first point of interest over a first time period. For example, the frequency can equal a number of visits per a standard increment of time (e.g. once per month for the last six months).

As another example, the frequency can equal a number of visits by the user to the particular point of interest per a number of instances in which the user was located in a region in which the particular point of interest is located. For example, the region can be a neighborhood or city. Thus, if the particular point of interest is located in Chicago and the user has visited the particular point of interest each of three times the user has been located in Chicago, then the above-noted formulation of frequency will reflect the user's positive opinion of the particular point of interest with greater accuracy than a frequency based on units of time regardless of user location.

As yet another example, the frequency can equal a number of visits by the user to the particular point of interest per an amount of time for which the user was located in the region in which the particular point of interest is located. Thus, for example, the frequency can reflect the number of times the user visited the point of interest per a total amount of time the user was located in Chicago.

At (206) a change can be identified in the first signal after the first time period. For example, review determination module 118 can be implemented to monitor the first signal and identify the change after the first time period.

At (208) it can be determined whether the change identified at (206) includes a decrease in the frequency of visits by the user to the first point of interest. For example, it can be determined whether the identified change includes a decrease that satisfies one or more criteria.

As an example, at (208) it can be determined whether the first signal has decreased to below the threshold value. As another example, at (208) it can be determined whether the first signal has decreased by greater than a threshold amount and/or decreased by greater than a threshold percentage.

If it is determined at (208) that the change identified at (206) includes a decrease in the frequency of visits by the user to the first point of interest that satisfies one or more criteria, then method (200) can proceed to (210) and provide a diminished review for the user with respect to the point of interest. For example, providing a diminished review can include providing a negative review for the user with respect to the point of interest.

As another example, providing the diminished review at (210) can include reducing a review score previously provided by the user for the point of interest. For example, if the user previously provided a review score of 4/5 stars, then providing the diminished review can include reducing the review score to 3/5 stars.

Alternatively or additionally, providing the diminished review can include prompting the user to confirm or edit/elaborate on the previously contributed review. For example, the user can be prompted to confirm a reduction in the user's previous review.

As yet another example, providing the diminished review can include accelerating a decay associated with a review of the particular point of interest that was previously contributed by the user during the first time period. For example, in certain systems, user-contributed reviews may have a certain decay period in which their influence on search or rating systems wanes. Thus, providing the diminished review can include accelerating this decay period for the review previously contributed by the user.

As another example, providing the diminished review can include decreasing a probability that the point of interest is recommended as a search result. For example, in certain systems, the reviews for a particular point of interest can impact the probability that such particular point of interest is deemed a relevant and appropriate search result (e.g. higher rated points of interest are provided more often than lower rated points of interest). Thus, providing the diminished review can include reducing the probability that the point of interest is provided as a search result. For example, the impact of one or more reviews (e.g. the review previously contributed by the user) on search results can be eliminated or decreased.

However, referring again to (208), if it is determined at (208) that the change identified at (206) does not include a decrease in the frequency of visits that satisfies the one or more criteria, then method (200) can proceed to (212) and maintain a current review for the user with respect to the first point of interest. For example, maintaining the current review can include decelerating or eliminating a decay period for an existing review contributed by the user. As another example, if the user has not actively contributed an existing review, maintaining the current review can include maintaining a global score for the first point of interest with respect to the user.

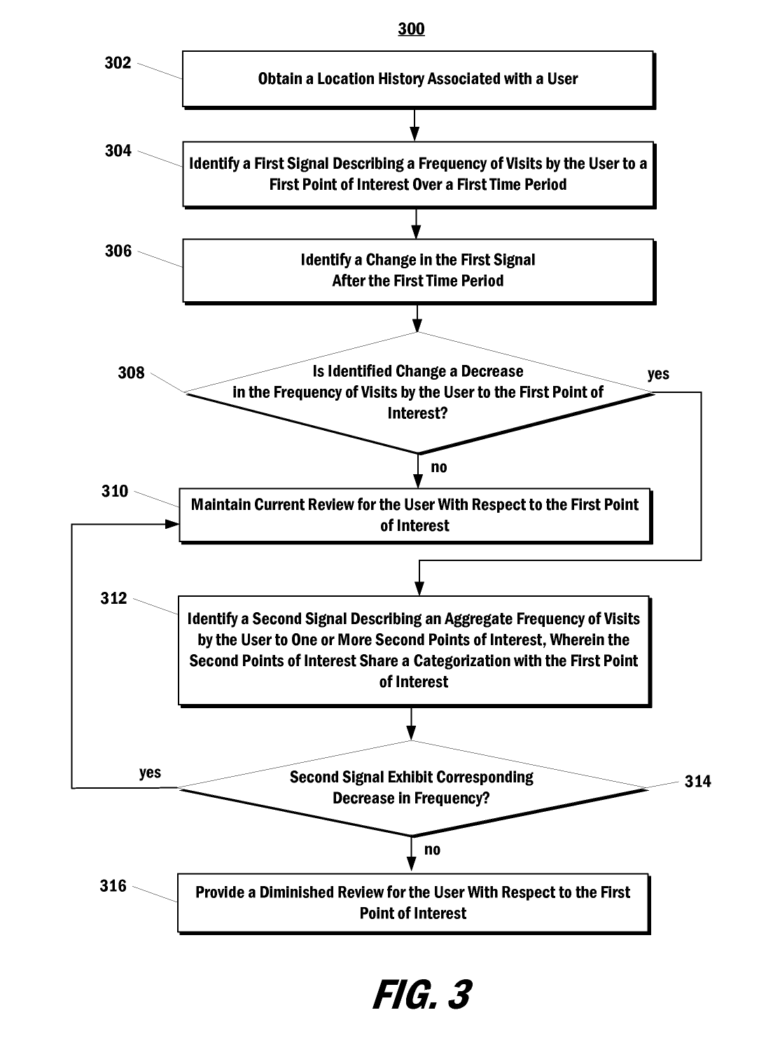

FIG. 3 depicts a flow chart of an example method (300) for providing reviews according to an example embodiment of the present disclosure. Although method (300) will be discussed with reference to system 100 of FIG. 1, method (300) can be performed by any suitable computing system.

In addition, FIG. 3 depicts steps performed in a particular order for purposes of illustration and discussion. Those of ordinary skill in the art, using the disclosures provided herein, will understand that the various steps of method (300) can be omitted, adapted, and/or rearranged in various ways without departing from the scope of the present disclosure.

At (302) a location history associated with a user can be obtained. For example, review determination system 102 can obtain a location history associated with a user from database 120. The obtained location history can describe a history of visits by the user to one or more points of interest.

At (304) a first signal exhibited by the location history obtained at (302) can be identified. In some embodiments, the first signal can be identified at (304) due to the first signal exceeding a threshold value. For example, review determination system 102 can implement review determination module 118 to analyze the obtained location history and identify the first signal. The first signal can describe a frequency of visits by the user to a first point of interest over a first time period.

At (306) a change can be identified in the first signal after the first time period. For example, review determination module 118 can be implemented to monitor the first signal and identify the change after the first time period.

At (308) it can be determined whether the change identified at (306) includes a decrease in the frequency of visits by the user to the first point of interest. For example, it can be determined whether the identified change includes a decrease that satisfies one or more criteria.

As an example, at (308) it can be determined whether the first signal has decreased to below the threshold value. As another example, at (308) it can be determined whether the first signal has decreased by greater than a threshold amount and/or decreased by greater than a threshold percentage.

If it is determined at (308) that the change identified at (306) does not include a decrease in the frequency of visits by the user to the first point of interest, then method (300) can proceed to (310) and maintain a current review for the user with respect to the first point of interest. For example, maintaining the current review can include decelerating or eliminating a decay period for an existing review contributed by the user. As another example, if the user has not actively contributed an existing review, maintaining the current review can include maintaining a global score for the first point of interest with respect to the user.

However, if it is determined at (308) that the change identified at (306) does include a decrease in the frequency of visits by the user to the first point of interest that satisfies one or more criteria, then method (300) can proceed to (312).

At (312) a second signal exhibited by the location history can be identified. The second signal can describe an aggregate frequency of visits by the user to one or more second points of interest. In particular, the one or more second points of interest can be points of interest that share a categorization with the first point of interest. For example, the categorization can be a type of point of interest (e.g. retail, food, beverage, entertainment, leisure); a sub-categorization (e.g. Italian restaurant, Mexican restaurant, Thai restaurant); or categorizations based on prices, styles, clientele, size of the point of interest (e.g. size of an entertainment venue), whether the point of interest is an independent entity or a member of a franchise or chain, or other suitable categorizations.

At (314) it can be determined whether the second signal exhibits a decrease in the aggregate frequency of visits by the user to one or more second points of interest that corresponds to the decrease exhibited by the first signal. For example, review determination module 118 can be implemented to compare a rate of decrease exhibited by each of the first and second signal, an amount of decrease exhibited by the first and second signal, and/or a percentage decrease exhibited by each of the first and second signal to identify whether the second signal exhibits a corresponding decrease.

If it is determined at (314) that the second signal does exhibit a corresponding decrease in frequency of visits, then method (300) can proceed to (310) and maintain the current review for the user with respect to the first point of interest. Thus, if the aggregate frequency of visits to the one or more other points of interest with the same categorization shows a decrease that corresponds with the decrease in frequency of visits to the first point of interest, then perhaps the user has grown tired of points of interest satisfying such categorization or is exploring additional flavors/categories. In such scenario, the user's opinion of the first point of interest has not necessarily diminished and, therefore, a diminished review may not be appropriate.

However, if it is determined at (314) that the second signal does not exhibit a corresponding decrease in frequency of visits, then method (300) can proceed to (316) and provide a diminished review for the user with respect to the first point of interest. Thus, if the aggregate frequency of visits to the one or more other points of interest with the same categorization does not show a corresponding decrease, then the user is visiting points of interest of the same categorization with the same frequency except for the first point of interest. In such situation, it can be assumed that the user's opinion of the first point of interest has diminished and, therefore, a diminished review can be provided.

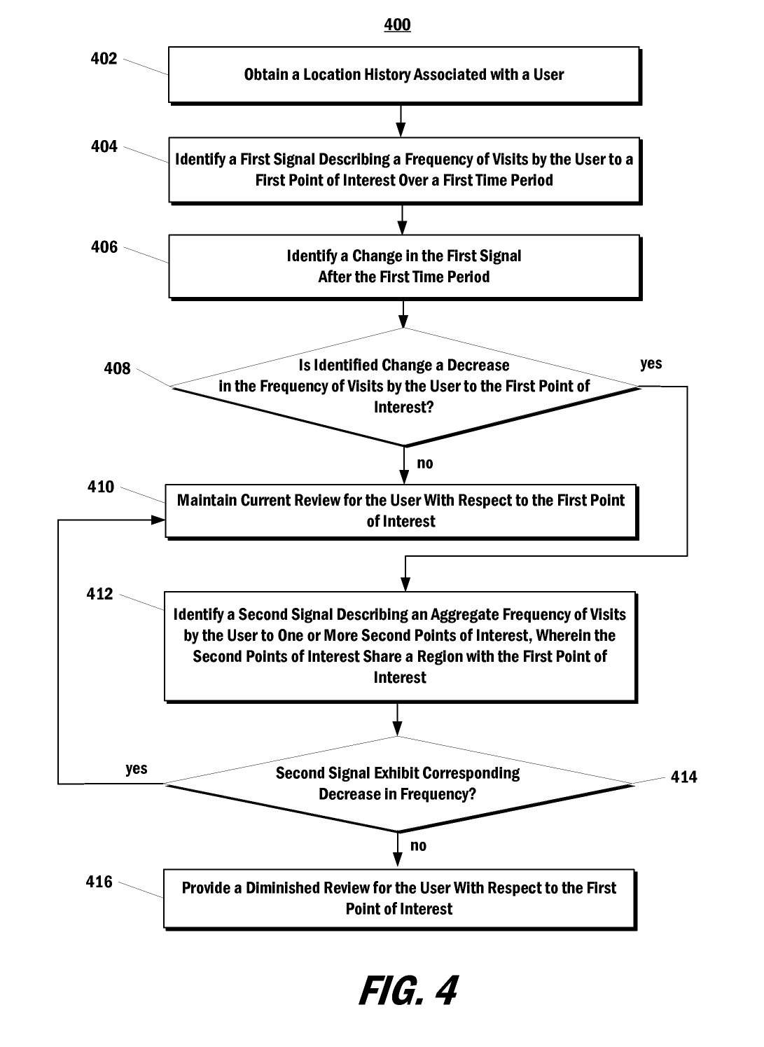

FIG. 4 depicts a flow chart of an example method (400) for providing reviews according to an example embodiment of the present disclosure. Although method (400) will be discussed with reference to system 100 of FIG. 1, method (400) can be performed by any suitable computing system.

In addition, FIG. 4 depicts steps performed in a particular order for purposes of illustration and discussion. Those of ordinary skill in the art, using the disclosures provided herein, will understand that the various steps of method (400) can be omitted, adapted, and/or rearranged in various ways without departing from the scope of the present disclosure.

At (402) a location history associated with a user can be obtained. For example, review determination system 102 can obtain a location history associated with a user from database 120. The obtained location history can describe a history of visits by the user to one or more points of interest.

At (404) a first signal exhibited by the location history obtained at (402) can be identified. In some embodiments, the first signal can be identified at (404) due to the first signal exceeding a threshold value. For example, review determination system 102 can implement review determination module 118 to analyze the obtained location history and identify the first signal. The first signal can describe a frequency of visits by the user to a first point of interest over a first time period.

At (406) a change can be identified in the first signal after the first time period. For example, review determination module 118 can be implemented to monitor the first signal and identify the change after the first time period.

At (408) it can be determined whether the change identified at (406) includes a decrease in the frequency of visits by the user to the first point of interest. For example, it can be determined whether the identified change includes a decrease that satisfies one or more criteria.

As an example, at (408) it can be determined whether the first signal has decreased to below the threshold value. As another example, at (408) it can be determined whether the first signal has decreased by greater than a threshold amount and/or decreased by greater than a threshold percentage.

If it is determined at (408) that the change identified at (406) does not include a decrease in the frequency of visits by the user to the first point of interest, then method (400) can proceed to (410) and maintain a current review for the user with respect to the first point of interest. For example, maintaining the current review can include decelerating or eliminating a decay period for an existing review contributed by the user. As another example, if the user has not actively contributed an existing review, maintaining the current review can include maintaining a global score for the first point of interest with respect to the user.

However, if it is determined at (408) that the change identified at (406) does include a decrease in the frequency of visits by the user to the first point of interest that satisfies one or more criteria, then method (400) can proceed to (412).

At (412) a second signal exhibited by the location history can be identified. The second signal can describe an aggregate frequency of visits by the user to one or more second points of interest. In particular, the one or more second points of interest can be points of interest that share a region with the first point of interest. For example, the region can be a city, neighborhood, street, zoning, or other suitable regions or combinations of regions.

As another example, in some embodiments, regions can correspond to bands of distance from a particular location, such as, for example, the user's home or work location. Thus, for example, all points of interest within 5 minutes of expected travel time from the user's home may be designated within a first region, all points of interest within 6-10 minutes of expected travel time from the user's home may be designated within a second region, etc.

At (414) it can be determined whether the second signal exhibits a decrease in the aggregate frequency of visits by the user to one or more second points of interest that corresponds to the decrease exhibited by the first signal. For example, review determination module 118 can be implemented to compare a rate of decrease exhibited by each of the first and second signal, an amount of decrease exhibited by the first and second signal, and/or a percentage decrease exhibited by each of the first and second signal to identify whether the second signal exhibits a corresponding decrease.

If it is determined at (414) that the second signal does exhibit a corresponding decrease in frequency of visits, then method (400) can proceed to (410) and maintain the current review for the user with respect to the first point of interest. Thus, if the aggregate frequency of visits to the one or more other points of interest in the same region shows a decrease that corresponds with the decrease in frequency of visits to the first point of interest, then perhaps the user has grown tired of visiting such region, has moved away from such region, or is exploring additional regions. In such scenario, the user's opinion of the first point of interest has not necessarily diminished and, therefore, a diminished review may not be appropriate.

However, if it is determined at (414) that the second signal does not exhibit a corresponding decrease in frequency of visits, then method (400) can proceed to (416) and provide a diminished review for the user with respect to the first point of interest. Thus, if the aggregate frequency of visits to the one or more other points of interest within the same region does not show a corresponding decrease, then the user is visiting points of interest in the same region with the same frequency except for the first point of interest. In such situation, it can be assumed that the user's opinion of the first point of interest has diminished and, therefore, a diminished review can be provided.

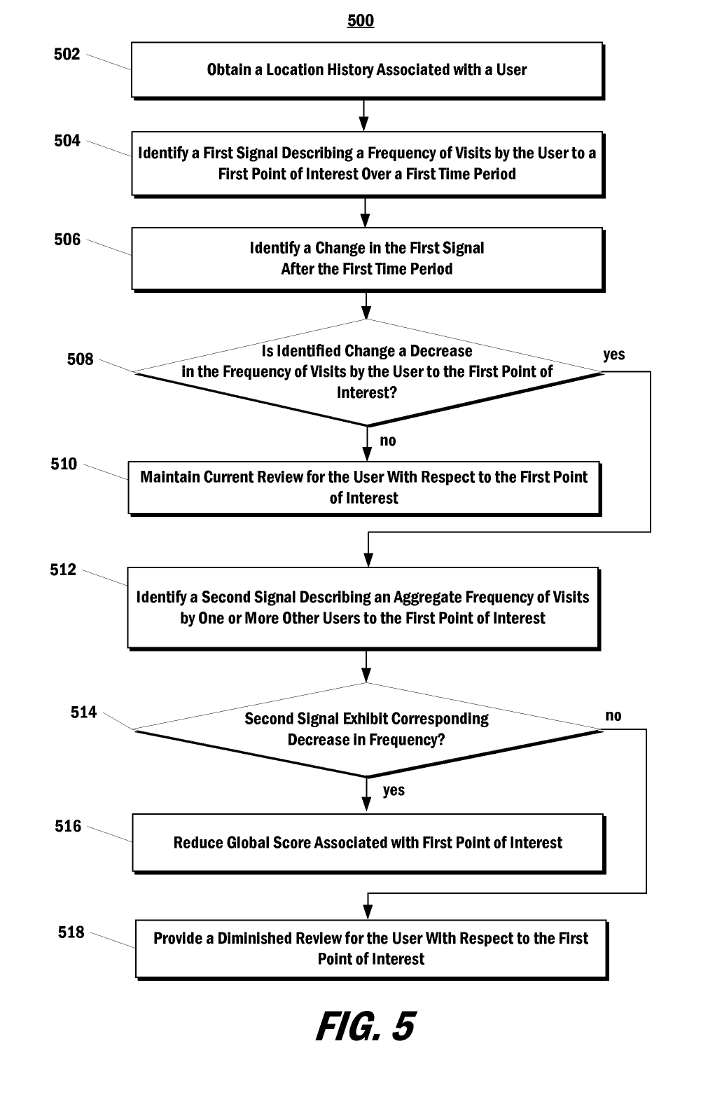

FIG. 5 depicts a flow chart of an example method (500) for providing reviews according to an example embodiment of the present disclosure. Although method (500) will be discussed with reference to system 100 of FIG. 1, method (500) can be performed by any suitable computing system.

In addition, FIG. 5 depicts steps performed in a particular order for purposes of illustration and discussion. Those of ordinary skill in the art, using the disclosures provided herein, will understand that the various steps of method (500) can be omitted, adapted, and/or rearranged in various ways without departing from the scope of the present disclosure.

At (502) a location history associated with a user can be obtained. For example, review determination system 102 can obtain a location history associated with a user from database 120. The obtained location history can describe a history of visits by the user to one or more points of interest.

At (504) a first signal exhibited by the location history obtained at (502) can be identified. In some embodiments, the first signal can be identified at (504) due to the first signal exceeding a threshold value. For example, review determination system 102 can implement review determination module 118 to analyze the obtained location history and identify the first signal. The first signal can describe a frequency of visits by the user to a first point of interest over a first time period.

At (506) a change can be identified in the first signal after the first time period. For example, review determination module 118 can be implemented to monitor the first signal and identify the change after the first time period.

At (508) it can be determined whether the change identified at (506) includes a decrease in the frequency of visits by the user to the first point of interest. For example, it can be determined whether the identified change includes a decrease that satisfies one or more criteria.

As an example, at (508) it can be determined whether the first signal has decreased to below the threshold value. As another example, at (508) it can be determined whether the first signal has decreased by greater than a threshold amount and/or decreased by greater than a threshold percentage.

If it is determined at (508) that the change identified at (506) does not include a decrease in the frequency of visits by the user to the first point of interest, then method (500) can proceed to (510) and maintain a current review for the user with respect to the first point of interest. For example, maintaining the current review can include decelerating or eliminating a decay period for an existing review contributed by the user. As another example, if the user has not actively contributed an existing review, maintaining the current review can include maintaining a global score for the first point of interest with respect to the user.

However, if it is determined at (508) that the change identified at (506) does include a decrease in the frequency of visits by the user to the first point of interest that satisfies one or more criteria, then method (500) can proceed to (512).

At (512) a second signal can be identified. The second signal can describe an aggregate frequency of visits by one or more other users to the first point of interest. Thus, identifying the second signal at (512) can include obtaining one or more additional location histories associated with the one or more other users and analyzing such additional location histories to identify the second signal. Furthermore, in some embodiments, the one or more other users used to define the second signal can be limited to users that share a region, share preferences, or have other corresponding features with respect to the first user.

At (514) it can be determined whether the second signal exhibits a decrease in the aggregate frequency of visits by the one or more other users to the first point of interest that corresponds to the decrease exhibited by the first signal. For example, review determination module 118 can be implemented to compare a rate of decrease exhibited by each of the first and second signal, an amount of decrease exhibited by the first and second signal, and/or a percentage decrease exhibited by each of the first and second signal to identify whether the second signal exhibits a corresponding decrease.

If it is determined at (514) that the second signal does exhibit a corresponding decrease in frequency of visits, then method (500) can proceed to (516) and reduce a global score associated with the first point of interest. Thus, if the aggregate frequency of visits by the one or more other users to the first point of interest shows a decrease that corresponds with the decrease in frequency of visits by the first user to the first point of interest, then it can be assumed that something has changed at the first point of interest that has diminished the users' aggregate opinion of the first point of interest, as reflected by the decrease in aggregate frequency. Therefore, diminishing (e.g. reducing) a global score for the first point of interest may be appropriate.

However, if it is determined at (514) that the second signal does not exhibit a corresponding decrease in frequency of visits, then method (500) can proceed to (516) and provide a diminished review for the user with respect to the first point of interest. Thus, if the aggregate frequency of visits by the one or more other users to the first point of interest does not show a corresponding decrease, then the reduced frequency of visits by the first user appears to be idiosyncratic with respect to the other users. In such situation, it may be appropriate to provide a diminished review only for the first user, and the leave a global score unadjusted.

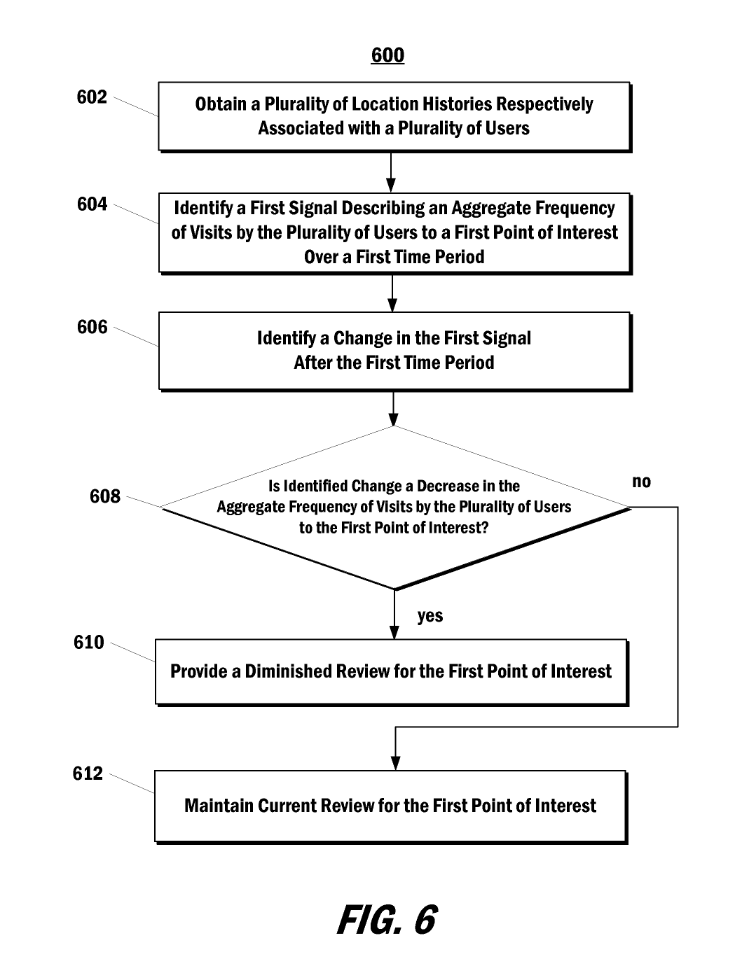

FIG. 6 depicts a flow chart of an example method (600) for providing reviews according to an example embodiment of the present disclosure. Although method (600) will be discussed with reference to system 100 of FIG. 1, method (600) can be performed by any suitable computing system.

In addition, FIG. 6 depicts steps performed in a particular order for purposes of illustration and discussion. Those of ordinary skill in the art, using the disclosures provided herein, will understand that the various steps of method (600) can be omitted, adapted, and/or rearranged in various ways without departing from the scope of the present disclosure.

At (602) a plurality of location histories respectively associated with a plurality of users can be obtained. For example, review determination system 102 can obtain a plurality of location histories respectively associated with a plurality of users from database 120. The obtained location histories can describe a history of visits by the plurality of users to one or more points of interest.

At (604) a first signal exhibited by the location histories obtained at (602) can be identified. In some embodiments, the first signal can be identified at (604) due to the first signal exceeding a threshold value. For example, review determination system 102 can implement review determination module 118 to analyze the obtained location history and identify the first signal.

The first signal can describe an aggregate frequency of visits by the plurality of users to a first point of interest over a first time period.

At (606) a change can be identified in the first signal after the first time period. For example, review determination module 118 can be implemented to monitor the first signal and identify the change after the first time period.

At (608) it can be determined whether the change identified at (606) includes a decrease in the aggregate frequency of visits by the plurality of users to the first point of interest. For example, it can be determined whether the identified change includes a decrease that satisfies one or more criteria.

As an example, at (608) it can be determined whether the first signal has decreased to below the threshold value. As another example, at (608) it can be determined whether the first signal has decreased by greater than a threshold amount and/or decreased by greater than a threshold percentage.

If it is determined at (608) that the change identified at (606) includes a decrease in the aggregate frequency of visits by the plurality of users to the first point of interest that satisfies one or more criteria, then method (600) can proceed to (610) and provide a diminished review for the first point of interest.

For example, providing a diminished review at (610) can include providing a negative review for the first point of interest. As another example, providing the diminished review at (610) can include reducing a global score associated with the first point of interest.

Alternatively or additionally, providing the diminished review can include prompting one or more of the plurality of users to confirm or edit/elaborate on one or more previously contributed reviews.

As yet another example, providing the diminished review at (610) can include accelerating a decay associated with one or more reviews of the first point of interest that were previously contributed by one or more of the plurality of users during the first time period. For example, in certain systems, user-contributed reviews may have a certain decay period in which their influence on search or rating systems wanes. Thus, providing the diminished review can include accelerating this decay period for one or more reviews previously contributed by the plurality of users.

As another example, providing the diminished review at (610) can include decreasing a probability that the point of interest is recommended as a search result. For example, in certain systems, the reviews for a particular point of interest can impact the probability that such particular point of interest is deemed a relevant and appropriate search result (e.g. higher rated points of interest are provided more often than lower rated points of interest). Thus, providing the diminished review can include reducing the probability that the point of interest is provided as a search result. For example, the impact of one or more reviews on search results can be eliminated or decreased.

However, referring again to (608), if it is determined at (608) that the change identified at (606) does not include a decrease in the frequency of visits that satisfies the one or more criteria, then method (600) can proceed to (612) and maintain a current review for the first point of interest. For example, maintaining the current review can include decelerating or eliminating a decay period for one or more existing reviews contributed by the plurality of users. As another example, maintaining the current review can include maintaining a global score for the first point of interest.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A system for providing reviews, the system comprising:
one or more computing devices; and
one or more non-transitory computer-readable media storing instructions that, when executed by the one or more computing devices, cause the one or more computing devices to perform operations, the operations comprising:
identifying, based on a location history associated with a user, a first signal, the first signal comprising a frequency of visits by the user to a first point of interest over a first time period;
identifying, based on the location history associated with the user, a change in the first signal after the first time period; and
when the identified change comprises a decrease in the frequency of visits by the user to the first point of interest, providing a diminished review for the user with respect to the first point of interest, wherein providing the diminished review comprises accelerating a decay associated with a previous review contributed by the user with respect to the first point of interest during the first time period.

2. The system of claim 1, the operations further comprising:
identifying, based on the location history associated with the user, a second signal, the second signal comprising an aggregate frequency of visits by the user to a plurality of second points of interest, wherein the second points of interest share a categorization with the first point of interest; and
determining, based on the plurality of second location histories, whether the second signal exhibits a decrease in the aggregate frequency of visits by the user to the plurality of second points of interest after the first time period,
wherein the diminished review for the user with respect to the first point of interest is provided only when the second signal does not exhibit a decrease in the aggregate frequency of visits by the user to the plurality of second points of interest after the first time period.

3. The system of claim 2, wherein the categorization shared by the first and second points of interest comprises a style of restaurant.

4. The system of claim 1, the operations further comprising:
identifying, based on the location history associated with the user, a second signal, the second signal comprising an aggregate frequency of visits by the user to a plurality of second points of interest, wherein the second points of interest are located in a same region as the first point of interest; and
determining, based on the plurality of second location histories, whether the second signal exhibits a decrease in the aggregate frequency of visits by the user to the plurality of second points of interest after the first time period,
wherein the diminished review for the user with respect to the first point of interest is provided only when the second signal does not exhibit a decrease in the aggregate frequency of visits by the user to the plurality of second points of interest after the first time period.

5. The system of claim 1, the operations further comprising:
identifying, based on a plurality of second location histories respectively associated with a plurality of second users, a second signal, the second signal comprising an aggregate frequency of visits by the plurality of second users to the first point of interest;
determining, based on the plurality of second location histories, whether the second signal exhibits a decrease in the aggregate frequency of visits after the first time period; and
when the second signal exhibits a decrease in the aggregate frequency of visits after the first time period, reducing a score associated with the first point of interest.

6. The system of claim 1, wherein the frequency of visits by the user to the first point of interest comprises a number of visits by the user to the first point of interest per a number of instances in which the user was located in a region in which the first point of interest is located.

7. The system of claim 6, wherein the region comprises a city or a neighborhood.

8. The system of claim 1, wherein the frequency of visits by the user to the first point of interest comprises a number of visits by the user to the first point of interest per an amount of time during which the user was located in a region in which the first point of interest is located.

9. The system of claim 1, wherein the diminished review comprises a negative review.

10. The system of claim 1, wherein providing a diminished review for the user with respect to the first point of interest comprises decreasing a score for the first point of interest.

11. (canceled)

12. A method for providing reviews, the method comprising:
obtaining, by one or more computing devices, a plurality of location histories respectively associated with a plurality of users, the location history for each user providing a history of visits by such user to a plurality of points of interest over time;
identifying, by the one or more computing devices based on the plurality of location histories, a first signal, the first signal comprising an aggregate frequency of visits by the plurality of users to a first point of interest over a first time period;
identifying, by the one or more computing devices based on the plurality of location histories, a change in the first signal after the first time period; and
when the identified change comprises a decrease in the aggregate frequency of visits by the plurality of users to the first point of interest, providing, by the one or more computing devices, a diminished review for the first point of interest, wherein providing the diminished review comprises accelerating a decay associated with a previous review contributed by a user of the plurality of users with respect to the first point of interest during the first time period.

13. The method of claim 12, wherein the plurality of users comprises users associated with a region in which the first point of interest is located.

14. The method of claim 12, wherein identifying, by the one or more computing devices based on the plurality of location histories, a change in the first signal after the first time period comprises identifying, by the one or more computing devices based on the plurality of location histories, a percentage decrease in the aggregate frequency of visits by the plurality of users to the first point of interest that is greater than a threshold percentage.

15. The method of claim 12, wherein identifying, by the one or more computing devices based on the plurality of location histories, a change in the first signal after the first time period comprises identifying, by the one or more computing devices based on the plurality of location histories, when the aggregate frequency of visits by the plurality of users to the first point of interest decreases below a threshold value, and wherein the diminished review is provided when it is identified that the aggregate frequency of visits by the plurality of users to the first point of interest has decreased below the threshold value.

16. The method of claim 12, wherein providing, by the one or more computing devices, the diminished review for the first point of interest comprises decreasing, by the one or more computing devices, a probability that the first point of interest will be recommended as a search result.

17. A method for providing reviews, the method comprising:
identifying, by one or more computing devices, a first signal that is greater than a threshold value, the first signal being exhibited by a location history associated with a user, and wherein the first signal comprises a frequency of visits by the user to a first point of interest;
determining, by the one or more computing devices, whether the first signal exhibited by the location history has decreased in value; and
when it is determined that the first signal has decreased in value, providing, by the one or more computing devices, a diminished review for the first point of interest, wherein providing the diminished review comprises accelerating a decay associated with a previous review contributed by the user with respect to the first point of interest.

18. The method of claim 17, wherein:
determining, by the one or more computing devices, whether the first signal exhibited by the location history has decreased in value comprises determining, by the one or more computing devices, whether the first signal exhibited by the location history is less than the threshold value; and
the diminished review for the first point of interest is provided when it is determined that the first signal exhibited by the location history is less than the threshold value.

19. The method of claim 17, wherein:
determining, by the one or more computing devices, whether the first signal exhibited by the location history has decreased in value comprises determining, by the one or more computing devices, whether the first signal exhibited by the location history has decreased in value by greater than a threshold percentage; and
the diminished review for the first point of interest is provided when it is determined that the first signal exhibited by the location history has decreased in value by greater than a threshold percentage decrease.

20. The method of claim 17, wherein:
determining, by the one or more computing devices, whether the first signal exhibited by the location history has decreased in value comprises determining, by the one or more computing devices, whether the first signal exhibited by the location history has decreased in value by greater than a threshold amount; and
the diminished review for the first point of interest is provided when it is determined that the first signal exhibited by the location history has decreased in value by greater than a threshold amount.
